(19) United States
(12) Patent Application Publication
(10) Pub. No.: US 2002/0062599 A1
(43) Pub. Date: May 30, 2002

(54) System for assembling a mobile element in a housing

(76) Inventors: Damien Cabanne, Fontainebleau (FR); Mark Lawrie, Sully-Sur-Loire (FR); Yann Le Gallo, Orleans (FR); Pascal De Vries, Sandillon (FR); Klaus Blume, Haan (DE); Charles Hopson, Lebanon, TN (US); Herve Laurandel, Herouville (FR); Simon Dobson, Folkstone (GB)

Correspondence Address: CARLSON, GASKEY & OLDS, P.C., 400 WEST MAPLE ROAD, SUITE 350, BIRMINGHAM, MI, 48009, US

(21) Appl. No.: 09/895,832

(22) Filed: Jun. 29, 2001

(30) Foreign Application Priority Data
Jul. 3, 2000 (FR) 00 08585

(51) Int. Cl. B60J 5/04; E05F 11/48

(52) U.S. Cl. 49/502; 49/352

(57) ABSTRACT

The present invention relates to a system for assembling and holding a mobile element of a system driving a mobile closure, in a housing made in a pre-formed plate. The mobile element is assembled and held in the housing by means of at least one pliable tongue.

This application claims priority to French Application FR 00 08585 filed Jul. 3, 2000.

### BACKGROUND OF THE INVENTION

The present invention relates to a system for assembling and holding a mobile element of a system for driving a mobile closure, in a housing made in a pre-formed sheet metal plate, and more particularly to a system for assembling and holding the drum of a window regulator of an automobile vehicle in its housing.

At the present time, the drums are housed within their covers and are held in their housing by imprisonment between the motor and the cover.

There are several drawbacks, for example if it is desired to dismantle the motor in the event of malfunctioning, the drum is no longer held in its housing. Another drawback is that it is not possible to assemble the window regulator on the door independently of the motor.

In Patent Application DE 19619087 A1 to Brose, the drum is imprisoned between the cover and the supporting sheet metal of the vehicle.

The motor may in that case be dismantled without dismantling the drum, but in that case, the window regulator cannot be transported as a complete entity, for example, between two assembly operations, as the cover must be assembled on the door panel, otherwise the drum is free and can be disengaged from its cover, this increasing the work load of the manipulators and reducing the flexibility of the organization of assembly.

DE 33 25 837 discloses a window regulator drum contained in a casing composed of two parts, of which one is made of plastics material and the other is made of sheet metal and comprises tongues which envelop the edge of the first part in order to ensure connection thereof. These tongues do not hold the drum in the housing of the casing.

It is an object of the invention to prevent the drum from escaping from its housing.

### SUMMARY OF THE INVENTION

The invention attains its object in that the mobile element is assembled and held captive in its housing by means of at least one pliable tongue formed in the pre-formed plate.

The invention is advantageously applied to a vehicle window regulator incorporating cables, in which the mobile element is a drum for winding cables.

This has the advantage of allowing easy transport of the cover/drum sub-system, as well as hold of the drum in its housing in the case of dismantling the motor for example.

### BRIEF DESCRIPTION OF THE DRAWINGS

The invention will be more readily understood on reading the following description given by way of non-limiting example, with reference to the accompanying drawings, in which:

FIG. 1 represents a system according to the prior art in perspective.

FIG. 2 represents a system according to the invention in perspective;

### DESCRIPTION OF PREFERRED EMBODIMENT

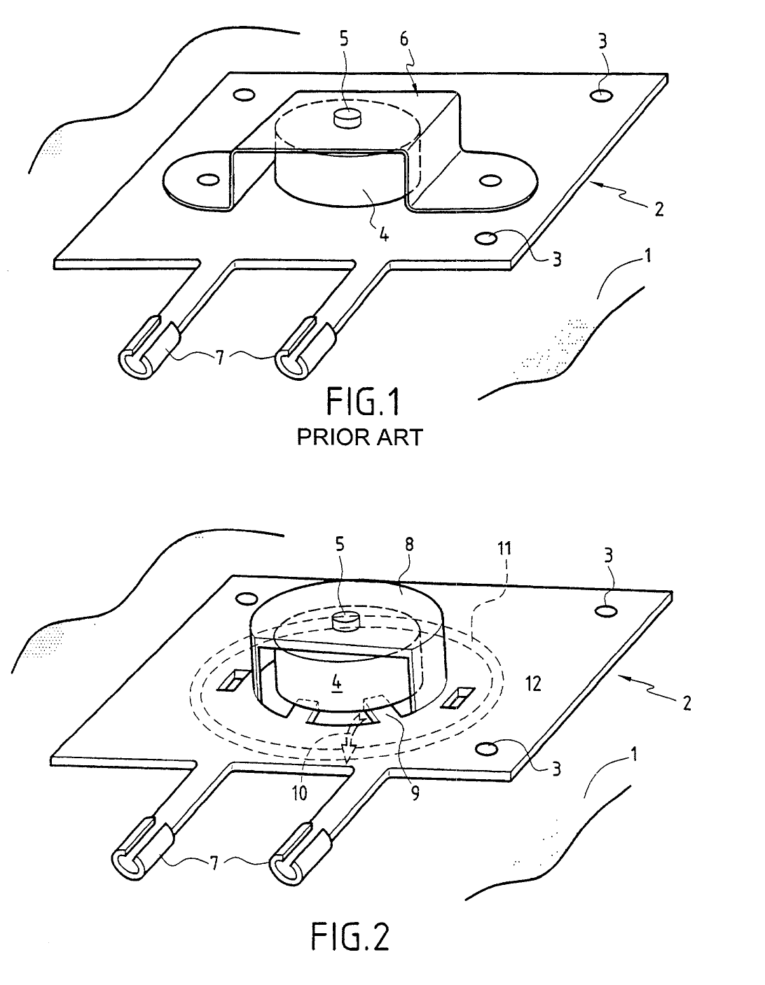

Referring now to the drawings, FIG. 1 represents the prior art. It shows the supporting plate 1 of the door of a vehicle, on which is secured a principal metallic plate 2 via screws or rivets 3. It also shows the drum 4 which is mounted in rotation on the shaft 5 and is maintained in position thanks to a cover 6 itself secured on the principal plate 2.

Extensions 7 of the principal plate 2 have been shaped and bent to form supports of pipes for the cables maneuvering the window (not shown in the drawings).

FIG. 2 shows a view of a system according to the invention in which the elements identical to those of FIG. 1 bear the same references.

The metallic plate 2 is stamped and cut out in order to make a housing for the drum 4 and at least one tongue 9 in the opening of the housing. The housing is defined by a U-shaped dish which presents lateral openings in particular for the passage of the cables.

The tongues 9 are formed by the lateral openings made during the cut-out and stamping operations. The bearing of the shaft 5 of the drum is also made during the stamping operation. The geometry of the dish 8 is not limiting. The only condition to be respected is that the drum 4 be maintained in position in its housing by the shaft 5 and at least one tongue 9.

This tongue 9 is pliable, being deformed in the direction of arrow 10 (downwardly) to allow passage of the drum 4, and the tongue 9 is then returned into position to hold the drum 4 in the housing between this tongue 9 and the U-shaped dish 8. The drum 4 is in that case captive, which facilitates transport of the elements and the exchange of the motor if needed.

An O-ring 11 may be positioned beneath the plate 2, thus obtaining an assembly which may be easily manipulated.

Holes 12 may be made on the plate 2, which will serve to house the elements for holding a manual drive system, for example a brake jacket in the case of a manual window regulator. Such holes will advantageously be placed within the perimeter of the O-ring, in order to guarantee seal of the system in the case of a motorized or manual window regulator, which will make it possible to have a single part 2 whether it be for a manual or electric window regulator.

It will be noted that this system reduces the number of components by combining the components 1 and 6 of the prior art.

A preferred embodiment of this invention has been disclosed. However, a worker of ordinary skill in this art would recognize that certain modifications would come within the scope of this invention. For that reason, the following claims should be studied to determine the true scope and content of this invention.

What is claimed is:

1. A system for assembling and holding a mobile element of a drive system driving a mobile closure, comprising: a housing made in a pre-formed plate, and said mobile element is assembled and held captive in said housing by at least one pliable tongue formed in said pre-formed plate.

2. The system of claim 1, wherein said drive system is a vehicle window regulator.

3. The system of claim 1, wherein said mobile element is a drum.

4. The system of claim 1, wherein said pre-formed plate is a sheet metal plate.

5. The system of claim 4, wherein an O-ring is applied beneath said sheet metal plate.

6. The system of claim 5, wherein at least one hole is pierced in said sheet metal plate.

7. The system of claim 6, wherein a manual drive system is secured in said holes.

8. The system of claim 4, wherein at least one extension of said sheet metal plate forms the supports for pipes.

9. The system of claim 4, wherein said sheet metal plate and said drum are secured on a supporting plate by at least one securing member.

10. The system of claim 9, wherein said at least one securing member is removable.

11. A system for assembling and holding a mobile element of a vehicle window regulator driving a mobile closure, comprising: a housing made in a pre-formed plate, said mobile element is assembled and held captive in said housing by at least one pliable tongue formed in said pre-formed plate, and an O-ring applied beneath said pre-formed plate.

12. The system of claim 11, wherein said mobile element is a drum.

13. The system of claim 11, wherein said pre-formed plate is a sheet metal plate.

14. The system of claim 11, wherein at least one hole is pierced in said sheet metal plate.

15. The system of claim 13, wherein a manual drive system is secured in said holes.

16. The system of claim 11, wherein at least one extension of said pre-formed plate forms the supports for pipes.

17. The system of claim 11, wherein said pre-formed plate and said drum are secured on a supporting plate by at least one securing member.

18. The system of claim 16, wherein said at least one securing member is removable.
